(19) United States
(12) Patent Application Publication
(10) Pub. No.: US 2005/0286725 A1
(43) Pub. Date: Dec. 29, 2005

(54) Pseudo-stereo signal making apparatus

(76) Inventors: Yuji Yamada, Tokyo (JP); Koyuru Okimoto, Tokyo (JP)

Correspondence Address: JAY H. MAIOLI;Cooper & Dunham LLP, 1185 Avenue of the Americas, New York, NY, 10036, US

(21) Appl. No.: 11/151,089

(22) Filed: Jun. 13, 2005

(30) Foreign Application Priority Data
Jun. 29, 2004 (JP) P2004-191954

(51) Int. Cl. H04R 5/00; H04R 5/02

(52) U.S. Cl. 381/17; 381/18; 381/309

(57) ABSTRACT

To permit listeners to hear pseudo-stereo sounds with significantly reduced unpleasantness, an input signal xo(t) obtained by digitizing a monaural analog input signal S0 and partitioning the resultant digital signal for each one frame of a predetermined period of time is inputted to a sound source separation section. A sound source separation process based on generalized harmonic analysis is performed by the sound source separation section to separate the input signal xo(t) into a sound source signal DS and residual signal DT. Subsequently, the sound source signal DS and residual signal DT are converted from digital to analog form and amplified by an output processing section to generate output signals S1L and S1R. The sound of the output signals S1L and S1R is perceived by the listener as a pseudo-stereo sound via a headphone.

### CROSS REFERENCES TO RELATED APPLICATIONS

The present invention contains subject matter related to Japanese Patent Application JP2004-191954 filed in the Japanese Patent Office on Jun. 29, 2004, the entire contents of which being incorporated herein by reference.

### BACKGROUND OF THE INVENTION

1. Field of the Invention

The present invention relates to a pseudo-stereo signal making apparatus, which is suitable for being used as an apparatus which allows the listener to hear a pseudo-stereo sound, for example, via a headphone.

2. Description of the Related Art

There have hitherto been proposed pseudo-stereo signal making apparatuses in which multiple channels of sound signals uncorrelated to each other are created based on an inputted monaural sound signal, thereby allowing the listener to hear a pseudo-stereo sound capable of giving a laterally broadened sound image.

Among pseudo-stereo signal making apparatuses of this type, there is one in which multiple sound signals uncorrelated to each other are created from a monaural sound signal by using an uncorrelated-signal making filter for each output channel as shown in FIG. 1 and changing the phase of sound signal of a different frequency band for each of the uncorrelated-signal making filters as shown in FIG. 2.

Also, among the pseudo-stereo signal making apparatuses, there is one in which a monaural sound signal is divided into multiple frequency bands as shown in FIG. 3 by using bandpass filters instead of uncorrelated-signal making filters shown in FIG. 1, and then the sound signal of a different frequency band for each output channel is eliminated, thereby assigning signal components of each frequency band to different output channels (refer to Japanese Patent Laid-Open No. 8-205295 (p. 3, FIG. 4))

### SUMMARY OF THE INVENTION

In general, in a sound source which generates sounds, there are generated a fundamental sound and harmonic sounds thereof. Listeners are accustomed to perceiving such fundamental wave component and harmonic wave components of a sound from the same direction in daily lives. Consequently, when listeners hear the fundamental wave component and harmonic wave components of a sound from the same direction, they perceive unconsciously that the sound is natural.

With the above pseudo-stereo signal making apparatus, however, a sound signal is divided into prescribed-frequency band signals, and the resultant signals are assigned to different output channels. Thus the fundamental wave component and harmonic wave components of a sound may be assigned to different output channels.

In this case, the pseudo-stereo signal making apparatus causes the listener to hear the fundamental wave component and harmonic wave components of a sound from different directions. Consequently, while a laterally broadened sound image can be given to the listener, sound image localization will become unnatural, thus giving an unpleasant feeling to the user.

To address the above problem, the present invention provides a pseudo-stereo signal making apparatus capable of allowing the listener to hear a pseudo-stereo sound which gives a significantly small unpleasant feeling.

According to an embodiment of the present invention, there is provided a pseudo-stereo signal making apparatus including: sound source separation section for generating a sound source signal and at the same time generating a residual signal obtained by subtracting the sound source signal component from an input signal, the sound source signal being generated by acquiring the input signal composed of a monaural sound partitioned into predetermined analysis intervals, selecting from among periodic waves extractable from the input signal a fundamental periodic wave such that the energy of residual components obtained by subtracting the periodic wave from the input signal is minimal, and then extracting the fundamental periodic wave component and harmonic wave components thereof from the input signal and combining them; and output signal generation section for generating, based on the sound source signal, a first output signal corresponding to one channel and at the same time generating, based on the residual signal, a second output signal corresponding to another channel.

Accordingly, the input sound signal can be separated into the sound source signal composed of the periodic wave component and harmonic wave components thereof and the residual signal composed of the residual components, whereby the output sound signal in which the sound source signal and residual signal are assigned to different output channels can be generated and outputted as a pseudo-stereo sound.

Further, there is provided a pseudo-stereo signal making method including: a sound source separation step of generating a sound source signal and at the same time generating a residual signal obtained by subtracting the sound source signal component from an input signal, the sound source signal being generated by acquiring the input signal composed of a monaural sound partitioned into predetermined analysis intervals, selecting from among periodic waves extractable from the input signal a fundamental periodic wave such that the energy of residual components obtained by subtracting the periodic wave from the input signal is minimal, and then extracting the fundamental periodic wave component and harmonic wave components thereof from the input signal and combining them; and an output signal generation step of generating, based on the sound source signal, a first output signal corresponding to one channel and at the same time generating, based on the residual signal, a second output signal corresponding to another channel.

Accordingly, the input sound signal can be separated into the sound source signal composed of the periodic wave component and harmonic wave components thereof and the residual signal composed of the residual components, whereby the output sound signal in which the sound source signal and residual signal are assigned to different output channels can be generated and outputted as a pseudo-stereo sound.

Furthermore, there is provided a pseudo-stereo signal making program causing an information processing apparatus to execute a process of converting a monaural sound into a pseudo-stereo sound. The pseudo-stereo signal making program include: a sound source separation step of generating a sound source signal and at the same time generating a residual signal obtained by subtracting the sound source signal component from an input signal, the sound source signal being generated by acquiring the input signal composed of a monaural sound partitioned into predetermined analysis intervals, selecting from among periodic waves extractable from the input signal a fundamental periodic wave such that the energy of residual components obtained by subtracting the periodic wave from the input signal is minimal, and then extracting the fundamental periodic wave component and harmonic wave components thereof from the input signal and combining them; and an output signal generation step of generating, based on the sound source signal, a first output signal corresponding to one channel and at the same time generating, based on the residual signal, a second output signal corresponding to another channel.

Accordingly, the input sound signal can be separated into the sound source signal composed of the periodic wave component and harmonic wave components thereof and the residual signal composed of the residual components, whereby the output sound signal in which the sound source signal and residual signal are assigned to different output channels can be generated and outputted as a pseudo-stereo sound.

With the present invention, an input sound signal can be separated into a sound source signal composed of a periodic wave component and harmonic wave components thereof and a residual signal composed of residual components, whereby an output sound signal in which the sound source signal and residual signal are assigned to different output channels can be generated and outputted as a pseudo-stereo sound. Consequently, there can be implemented the pseudo-stereo signal making apparatus capable of allowing the listener to hear a pseudo-stereo sound which gives a significantly small unpleasant feeling.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing an exemplary configuration of pseudo-stereo signal making apparatuses in related art;

FIG. 2 is a schematic diagram showing an exemplary uncorrelated-signal making process (1);

FIG. 3 is a schematic diagram showing an exemplary uncorrelated-signal making process (2);

FIG. 4 is a block diagram showing a configuration of a pseudo-stereo signal making apparatus according to a first embodiment;

FIG. 5 is a flowchart showing a procedure of a pseudo-stereo signal making process according to the first embodiment;

FIG. 6 is a flowchart showing a sound source separation subroutine;

FIG. 7 is a block diagram showing a configuration of a pseudo-stereo signal making apparatus according to a second embodiment;

FIG. 8 is a flowchart showing a procedure of a pseudo-stereo signal making process according to the second embodiment;

FIG. 9 is a block diagram showing a configuration of a pseudo-stereo signal making apparatus according to a third embodiment;

FIG. 10 is a schematic diagram showing an example of sound image localization;

FIG. 11 is a schematic diagram for explaining the sound image localization according to the third embodiment;

FIG. 12 is a flowchart showing a procedure of a pseudo-stereo signal making process according to the third embodiment; and

FIG. 13 is a block diagram showing a configuration of a pseudo-stereo signal making apparatus according to another embodiment.

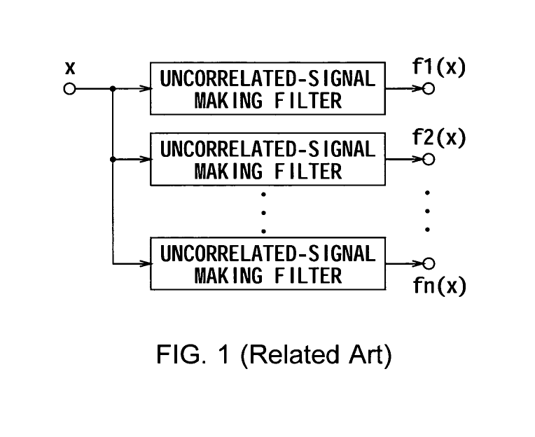

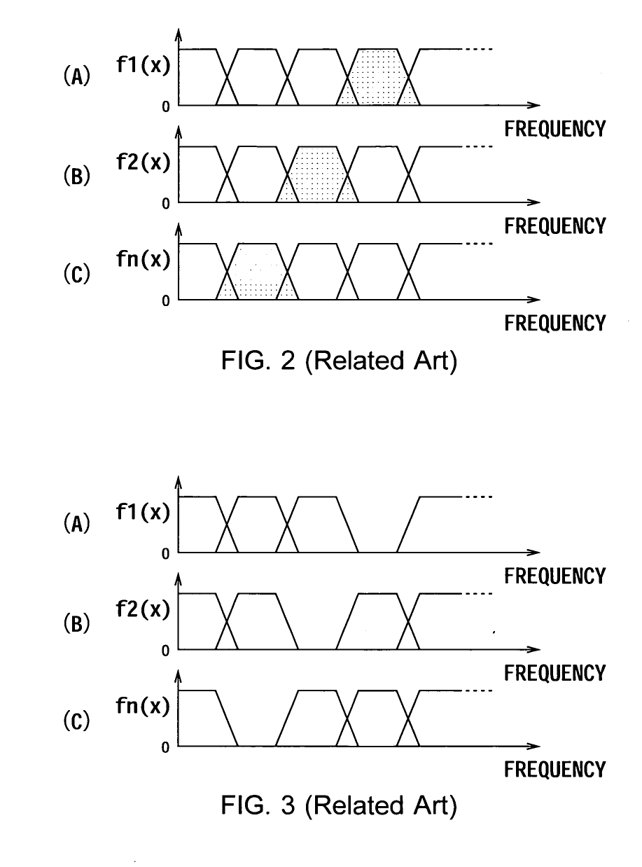

### DETAILED DESCRIPTION OF THE PREFERRED EMBODIMENTS

An embodiment of the present invention will be described below in detail with reference to the accompanying drawings.

### (1) First Embodiment

(1-1) Configuration of Pseudo-Stereo Signal Making Apparatus

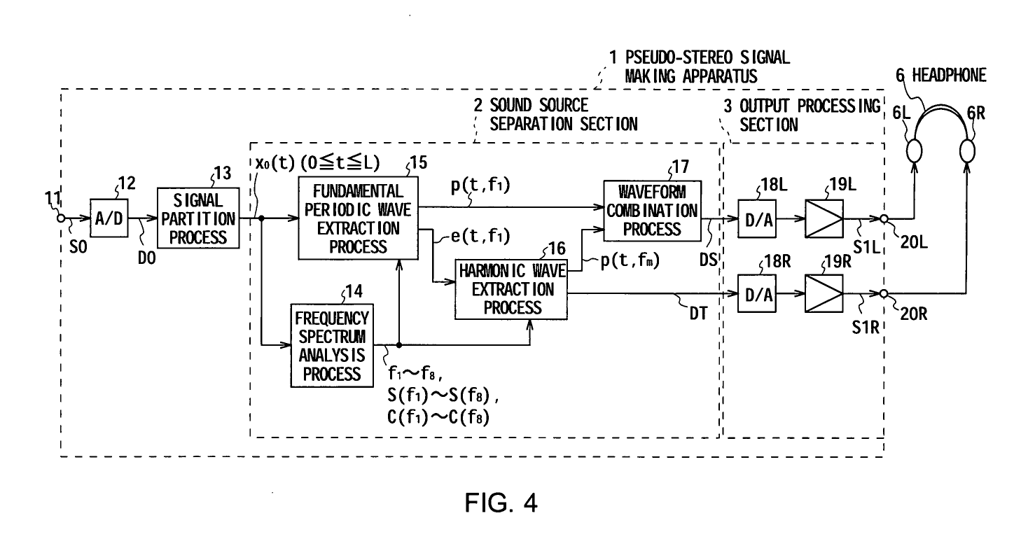

Referring to FIG. 4, reference numeral 1 denotes the entire configuration of a pseudo-stereo signal making apparatus according to a first embodiment of the present invention, which converts a monaural sound received from the outside into a pseudo-stereo sound, and thereby allows the listener to hear the resultant pseudo-stereo sound via a headphone 6.

In the pseudo-stereo signal making apparatus 1, a monaural analog sound signal S0 received from the outside via an input terminal 11 is digitized by an analog/digital converter 12 to convert into a digital input signal D0 and supplied to a signal partition processing circuit 13.

The signal partition processing circuit 13 partitions the digital input signal DO for each predetermined time interval L and then supplies the partitioned signal to a sound source separation section 2 as one frame of input signal xo(t) (0≦t≦L).

The sound source separation section 2 separates the input signal xo(t) into a sound source signal and a residual signal by use of a technique called generalized harmonic analysis. In the sound source separation section 2, firstly the input signal xo(t) supplied from the signal partition processing circuit 13 is supplied to a frequency spectrum analysis processing circuit 14 and a fundamental periodic wave extraction processing circuit 15.

The frequency spectrum analysis processing circuit 14, the details of which will be described later, calculates successively Fourier coefficients S(f) and C(f) of the input signal xo(t) while changing an arbitrary frequency f in varied ways, and calculates a periodic wave p(t, f) dependent on frequency f by use of the Fourier coefficients S(f) and C(f), and then calculates the energy E(f) of residue e(t, f) obtained by subtracting the periodic wave p(t, f) from the input signal xo(t).

In addition, the frequency spectrum analysis processing circuit 14 selects from among the varied frequencies f a frequency f at which the energy E(f) of residue is minimal (hereinafter, this frequency will be referred to as fundamental frequency f₁) and frequencies f at which the energy E(f) of residue is second to eighth smallest (hereinafter, these frequencies will be referred to as sub frequencies f₂ to f₈), and then supplies to the fundamental periodic wave extraction processing circuit 15 and a harmonic wave extraction processing circuit 16 the fundamental frequency f, and the sub frequencies f₂ to f₈, and Fourier coefficients S(f₂) to S(f₈) and Fourier coefficients C(f₂) to C(f₈) corresponding to each frequency.

The fundamental periodic wave extraction processing circuit 15 calculates fundamental periodic wave p(t, f₁) dependent on fundamental frequency f, and supplies the resultant component to a waveform combining processing circuit 17 and at the same time supplies to the harmonic wave extraction processing circuit 16 a residue e(t, f₁) (hereinafter, referred to as the intermediate residue) obtained by subtracting the fundamental periodic wave p(t, f₁) component from the input signal xo(t).

The harmonic wave extraction processing circuit 16 selects from among sub frequencies f₂ to f₈, sub frequencies fₘ (2≦m≦8, m: integer number) which correspond to harmonic waves of fundamental frequency f₁, i.e. are approximately integral multiples of fundamental frequency f₁, and supplies to the waveform combining processing circuit 17 all the periodic wave p(t, fₘ) components as harmonic waves, and at the same time, supplies to a digital/analog processing circuit 18R of an output processing section 3 a residual component obtained by subtracting all the periodic wave p(t, fₘ) components of the harmonic waves from the intermediate residue e(t, f₁) components, as residual signal DT.

The waveform combining processing circuit 17 combines the fundamental periodic wave p(t, f₁) component with all the periodic wave p(t, fₘ) components of the harmonic waves thereof to generate a sound source signal DS, and supplies the sound source signal DS to a digital/analog converter 18L of the output processing section 3.

As such, the sound source separation section 2 separates one frame of input signal xo(t) into the sound source signal DS and residual signal DT, and supplies these signals to the output processing section 3.

The pseudo-stereo signal making apparatus 1 converts each of the sound source signal DS and residual signal DT from digital to analog form by means of the digital/analog converters 18L and 18R of the output processing section 3, generates an output signal S1L being a first output signal and an output signal S1R being a second output signal by amplifying the above analog signals by means of amplifiers 19L and 19R, and sends via output terminals 20L and 20R the output signals S1L and S1R to left and right acoustic units 6L and 6R of a headphone 6, respectively.

As such, the pseudo-stereo signal making apparatus 1 separates the input signal xo(t) based on the monaural input signal S0 into the sound source signal DS and residual signal DT by means of the sound source separation section 2, and allows the listener to hear the sound of the output signals S1L and S1R generated based on the sound source signal DS and residual signal DT.

(1-2) Procedure of Pseudo-Stereo Signal Making process

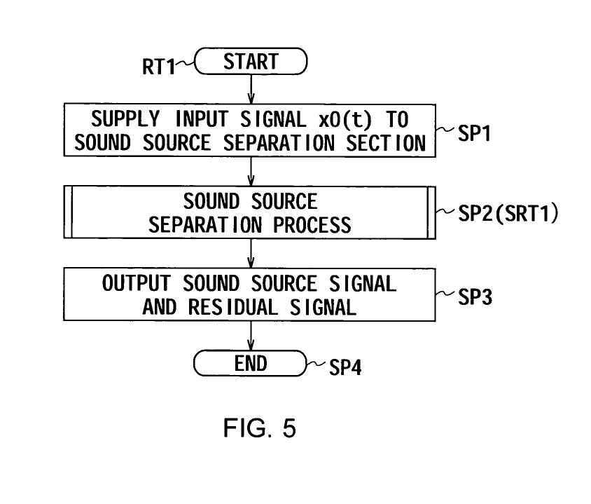

As described above, the pseudo-stereo signal making apparatus 1 generates a pseudo-stereo sound from a monaural sound by performing a sound source separation processing based on generalized harmonic analysis. The procedure of this pseudo-stereo signal making process will be described with reference to a flowchart of FIG. 5.

When a monaural analog input signal S0 is received from the outside via the input terminal 11, the process of the pseudo-stereo signal making apparatus 1 starts with start step of routine RT1 and proceeds to step SP1. In step SP1, the pseudo-stereo signal making apparatus 1 converts the monaural input signal S0 from analog to digital form by means of the analog/digital converter 12, and then supplies to the sound source separation section 2 an input signal xo(t) obtained by partitioning the digital input signal for each one frame of a predetermined period of time (0≦t≦L) by means of the signal partition processing circuit 13. Subsequently, the flow proceeds to step SP2.

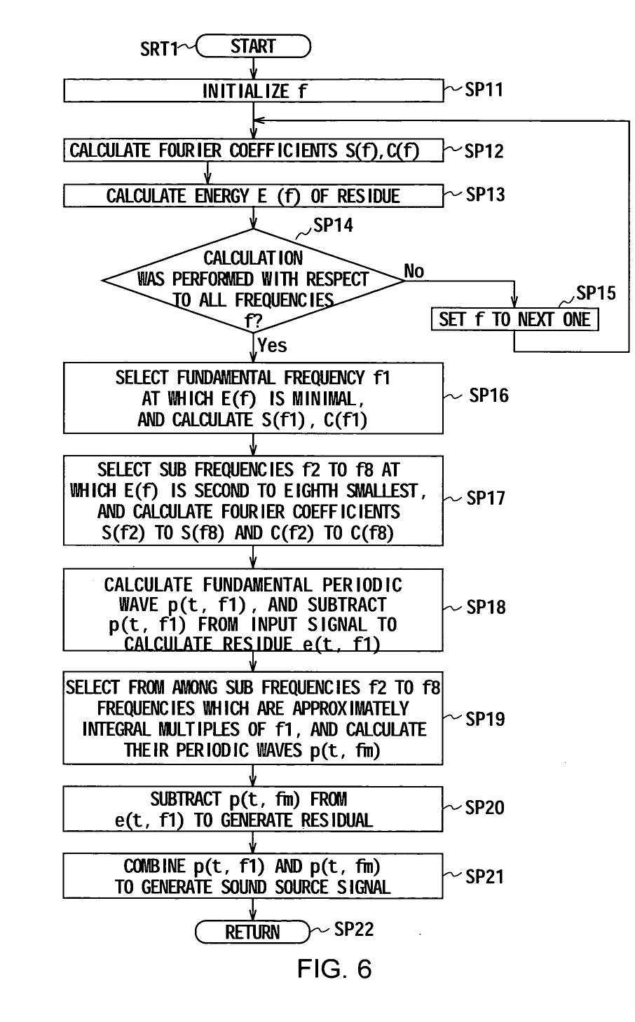

In step SP2, the pseudo-stereo signal making apparatus 1 proceeds to sound source separation subroutine SRT1 shown in FIG. 6, and starts with start step and then proceeds to step SP11. In step SP11, the sound source separation section 2 of the pseudo-stereo signal making apparatus 1 initializes frequency f used to calculate Fourier coefficient to 20 Hz by means of the frequency spectrum analysis processing circuit 14, and then proceeds to step SP12. The frequency spectrum analysis processing circuit 14 changes frequency f by 10 Hz from 20 Hz to 20 kHz.

In step SP12, by means of the frequency spectrum analysis processing circuit 14, the sound source separation section 2 calculates Fourier coefficients S(f) and C(f) dependent on the input signal xo(t) and frequency f according to the following formulas:

$$\begin{matrix}S ( f ) = \frac{2}{nT} {\int }_{0}^{nT} {x}_{0} ( t ) sin ( 2 π ft ) ⅆ t & ( 1 ) \\ C ( f ) = \frac{2}{nT} {\int }_{0}^{nT} {x}_{0} ( t ) cos ( 2 π ft ) ⅆ t & ( 2 )\end{matrix}$$

where period T is the inverse number of frequency f, and n is an integer number (nT≦L). Then the flow proceeds to step SP13.

In step SP13, by means of the frequency spectrum analysis processing circuit 14, the sound source separation section 2 calculates periodic wave p(t, f) by use of Fourier coefficients S(f) and C(f) according to the following formula:
p(t, f)=S(f)sin(2πft)+C(f)cos(2πft) (3)
and then calculates residue e(t, f) obtained by subtracting the periodic wave p(t, f) component from the input signal xo(t) according to the following formula:
e(t, f)=x₀(t)−S(f)sin(2πft)−C(f)cos(2πft) (4)
and then calculates the energy E(f) of residue according to the following formula:

$$E ( f ) = {\int }_{0}^{L} {e ( t , f )}^{2} ⅆ t \qquad ( 5 )$$

Then the flow proceeds to step SP14.

In step SP14, the sound source separation section 2 determines whether or not the energy E(f) of residue has been calculated with respect to all frequencies f ranging from 20 Hz to 20kHz by the frequency spectrum analysis processing circuit 14. If not, this means that the energy E(f) of residue may be further calculated with respect to another frequency f, and then the sound source separation section 2 proceeds to step SP15.

In step SP15, the sound source separation section 2 increases frequency f by 10 Hz in the frequency spectrum analysis processing circuit 14, and then returns to step SP12 to repeat steps 13 and 14.

On the other hand, if it is determined in step SP14 that the energy E(f) of residue has been calculated with respect to all frequencies ranging from 20 Hz to 20 kHz, then the sound source separation section 2 proceeds to step SP16.

In step SP16, by means of the frequency spectrum analysis processing circuit 14, the sound source separation section 2 selects a frequency f at which the energy E(f) of residue is minimal, as fundamental frequency f, from among the varied frequencies f, and calculates Fourier coefficients S(f₁) and C(f₁) with respect to this frequency, and then proceeds to step SP17.

It is noted here that fundamental frequency f₁ is a frequency at which the energy E(f) of residue is minimal, and thus at which the energy of periodic wave p(t, f) is maximum.

In step SP17, by means of the frequency spectrum analysis processing circuit 14, the sound source separation section 2 selects frequencies f at which the energy E(f) of residue is second to eighth smallest, as sub frequencies f₂ to f₈, and calculates Fourier coefficients S(f₂) to S(f₈) and Fourier coefficients C(f₂) to C(f₈) corresponding to each frequency, and supplies to the fundamental periodic wave extraction processing circuit 15 and the harmonic wave extraction processing circuit 16 the fundamental frequency f₁ and the sub frequencies f₂ to f₈, and Fourier coefficients S(f₁) to S(f₈) and Fourier coefficients C(f₁) to C(f₈). Then the section 2 proceeds to step SP18.

In step SP18, by means of the fundamental periodic wave extraction processing circuit 15, the sound source separation section 2 calculates the fundamental periodic wave p(t, f₁) component dependent on fundamental frequency f₁ by applying the fundamental frequency f₁, Fourier coefficients S(f₁) and C(f₁) to Formula 3, and supplies the calculated component to the waveform combining processing circuit 17.

In addition, by means of the fundamental periodic wave extraction processing circuit 15, the sound source separation section 2 calculates the intermediate residue e(t, f₁) component by subtracting the fundamental periodic wave p(t, f₁) component from the input signal xo(t), and supplies the calculated component to the harmonic wave extraction processing circuit 16, and then proceeds to step SP 19.

In step SP19, by means of the harmonic wave extraction processing circuit 16, the sound source separation section 2 selects from among sub frequencies f₂ to f₈ all sub frequencies fₘ which are approximately integral multiples of fundamental frequency f₁, and supplies all the periodic waves p(t, fₘ) components corresponding to the selected sub frequencies fm as harmonic waves to the waveform combining processing circuit 17, and then proceeds to step SP 20.

In step SP20, by means of the harmonic wave extraction processing circuit 16, the sound source separation section 2 generates residual signal DT by subtracting all the periodic wave p(t, fₘ) components of harmonic waves from the intermediate residue e(t, f₁) component, and supplies the generated signal to the digital/analog processing circuit 18R of the output processing section 3, and then proceeds to step SP21.

In step SP21, by means of the waveform combining processing circuit 17, the sound source separation section 2 combines the fundamental periodic wave p(t, f₁) component and all the periodic wave p(t, fₘ) components of harmonic waves to generate a sound source signal DS, and supplies the generated signal to the digital/analog converter 18L of the output processing section 3. Subsequently, the section 2 proceeds to step SP22 to terminate this subroutine SRT1, and then returns to step SP3 of routine RT1.

As such, by performing the sound source separation process using generalized harmonic analysis by means of the sound source separation section 2, the pseudo-stereo signal making apparatus 1 selects, based on a monaural input signal xo(t), fundamental frequency f₁ at which the energy E(f) of residue is minimal and the energy of periodic wave p(t, f) is maximum, and generates a sound source signal DS based on the fundamental frequency f₁ and the periodic wave components of the harmonic waves thereof and at the same time generates a residual signal DT composed of the residual components.

For example, when the sound component signal intensity of violoncello is largest in a monaural sound signal obtained by recording an orchestra performance, the pseudo-stereo signal making apparatus 1 extracts the sound component of violoncello including the harmonic waves thereof as the sound source signal DS, thereby making it possible to separate the residual signal DT composed of sound components of other musical instruments.

In step SP3, the pseudo-stereo signal making apparatus 1 converts the sound source signal DS and residual signal DT from digital to analog form and amplifies the analog signals by means of the output processing section 3, and outputs the amplified signals as output signals S1L and S1R via the output terminals 20L and 20R, respectively, and then proceeds to step SP14 to terminate this routine RT1.

The output signals S1L and S1R, generated based on the sound source signal DS and residual signal DT uncorrelated to each other, constitutes a pseudo-stereo sound obtained by assigning the sound of a sound source and the sound of residue thereof to different output channels.

By outputting the output signals S1L and S1R to the acoustic units 6L and 6R of the headphone 6, the pseudo-stereo signal making apparatus 1 can allow the listener to hear the sound of the output signals S1L and S1R as a pseudo-stereo sound.

For example, the pseudo-stereo signal making apparatus 1 can allow the listener to hear the above-described sound of violoncello and the sound of other musical instruments from the left channel and right channel, respectively.

(1-3) Operation and Effect

With the above described configuration, the pseudo-stereo signal making apparatus 1 supplies to the sound source separation section 2 an input signal xo(t) obtained by converting a monaural analog input signal S0 from digital to analog form and partitioning the digital signal for each one frame of a predetermined period of time, and then selects as fundamental frequency f₁ and sub frequencies f₂ to f₈, eight frequencies f at which the energy E(f) of residue e(t, f) obtained by subtracting periodic wave p(t, f) from the input signal xo(t) is minimal, by use of generalized harmonic analysis in the sound source separation section 2. Subsequently, the pseudo-stereo signal making apparatus 1 extracts from the input signal xo(t) the fundamental periodic wave p(t, f₁) component dependent on fundamental frequency f₁ and the periodic wave p(t, fₘ) dependent on sub frequencies f₂ to f₈ being approximately integral multiples of the fundamental frequency f₁, and generates a sound source signal DS by combining the fundamental periodic wave p(t, f₁) component and the periodic wave p(t, fₘ) components of harmonic waves, and at the same time generates a residual signal DT obtained by eliminating the sound source signal DS component from the input signal xo(t), and then, by means of the output processing section 3, converts the sound source signal DS and the residual signal DT from digital to analog form and amplifies the analog signals. The listener is caused to hear the sound of the resultant output signals S1L and S1R via the headphone 6.

Accordingly, by performing the sound source separation process based on generalized harmonic analysis in the sound source separation section 2, the pseudo-stereo signal making apparatus 1 can separate the input signal xo(t) into the sound source signal DS and residual signal DT, and in addition, by converting the sound source signal DS and residual signal DT from digital to analog form and assigning the signals to the left and right channels, can allow the listener to hear the sound of the signals as a pseudo-stereo sound.

In this case, for example, when the sound component signal intensity of violoncello is largest in a sound signal obtained by recording an orchestra performance, the pseudo-stereo signal making apparatus 1 can extract the sound component of violoncello including the harmonic waves thereof as the sound source signal DS, thereby separating the residual signal DT composed of sound of other musical instruments. Thus, the sound component of violoncello and that of other musical instruments can be supplied to the left and right acoustic units 6L and 6R of the headphone 6, thereby allowing the listener to perceive distinct sound image localization.

With the above described configuration, by means of the sound source separation section 2, the pseudo-stereo signal making apparatus 1 selects fundamental frequency f₁ based on an input signal xo(t) by use of generalized harmonic analysis, and generates sound source signal DS by combining fundamental periodic wave p(t, f₁) dependent on the fundamental frequency f₁ with periodic waves p(t, fₘ) of the harmonic waves of the fundamental frequency f₁ and at the same time generates residual signal DT obtained by eliminating the sound source signal DS component from the input signal xo(t). Subsequently, by means of the output processing section 3, the pseudo-stereo signal making apparatus 1 converts the sound source signal DS and residual signal DT from digital to analog form and amplifies the analog signals to generate analog output signals S1L and S1R, which are heard by the listener via the headphone 6. Thus, by separating the input signal xo(t) into the sound source signal DS and residual signal DT and then assigning the signals to different output channels, the listener can hear the pseudo-stereo sound having distinct sound image localization. Accordingly, there can be implemented the pseudo-stereo signal making apparatus capable of allowing the listener to hear a pseudo-stereo sound giving a significantly small unpleasant feeling.

### (2) Second Embodiment

(2-1) Configuration of Pseudo-Stereo Signal Making Apparatus

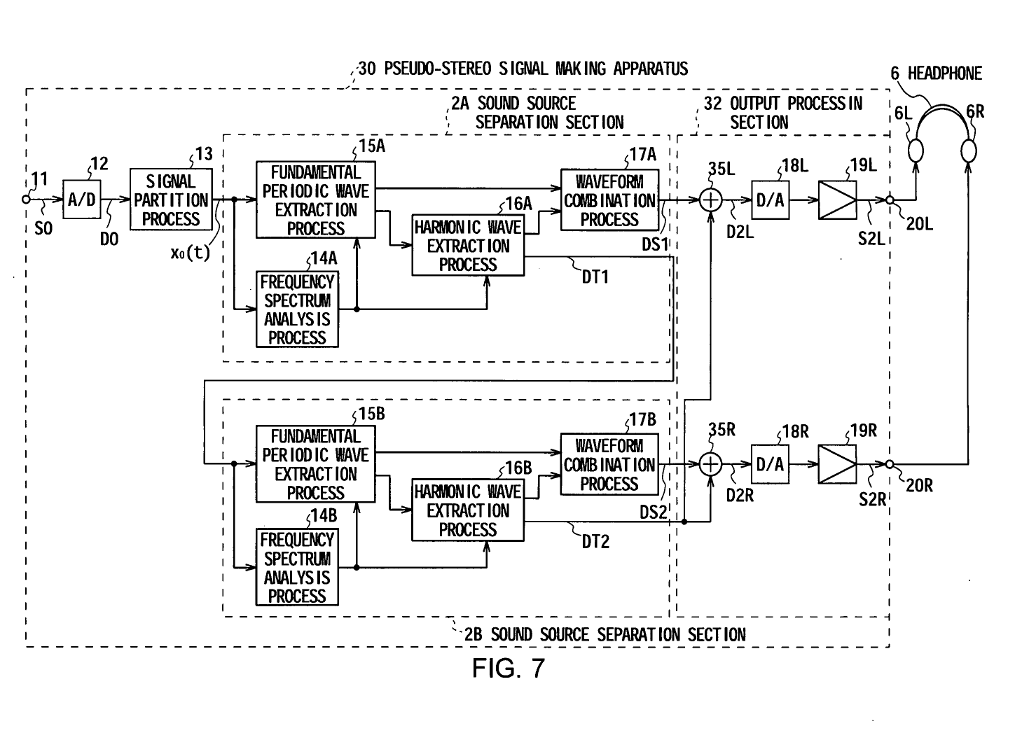

In FIG. 7 in which the same reference numerals are applied to parts corresponding to FIG. 4, reference numeral 30 denotes a pseudo-stereo signal making apparatus according to a second embodiment. The pseudo-stereo signal making apparatus 30 has a similar configuration to that of the first embodiment, except that it has sound source separation sections 2A and 2B having a similar configuration to the sound source separation section 2 (FIG. 4) and has an output processing section 32 instead of the output processing section 3 (FIG. 4).

Similarly to the pseudo-stereo signal making apparatus 1, the pseudo-stereo signal making apparatus 30 converts a monaural analog input signal S0 from analog to digital form by means of an analog/digital converter 12 to generate a digital input signal D0, and partitions the signal D0 for each one frame by means of a signal partition processing circuit 13. Then the input signal xo(t) thus partitioned is supplied to a sound source separation section 2A.

The sound source separation section 2A applies a process similar to that of the sound source separation section 2 to one frame of input signal xo(t) received from the signal partition processing circuit 13 to thereby separate the input signal into a first sound source signal DS1 and a first residual signal DT1, and supplies these signals to an output processing section 32 and sound source separation section 2B, respectively.

The sound source separation section 2B applies a process similar to that of the sound source separation section 2 to the first residual signal DT1 to thereby separate the signal DT1 into a second sound source signal DS2 and a second residual signal DT2, and supplies these signals to the output processing section 32.

The output processing section 32 adds the first sound source signal DS1 to the second residual signal DT2 by means of an adder 35L to thereby generate a digital output signal D2L, and also adds the second sound source signal DS2 to the second residual signal DT2 by means of an adder 35R to thereby generate a digital output signal D2R.

Then output processing section 32 converts the digital output signals D2L and D2R from digital to analog form by means of digital/analog processing circuits 18L and 18R, respectively, and amplifies these analog signals by means of amplifiers 19L and 19R to thereby generate an output signal S2L as first output signal, and an output signal S2R as second output signal. The output signals S2L and S2R are sent via output terminals 20L and 20R to left and right acoustic units 6L and 6R of the headphone 6.

As such, the pseudo-stereo signal making apparatus 30 separates, based on a monaural input signal SO, an input signal xo(t) into a first sound source signal DS1, second sound source signal DS2 and second residual signal DT2 by means of the sound source separation sections 2A and 2B, and adds the second residual signal DT2 to each of the first sound source signal DS1 and the second sound source signal DS2 to thereby generate the output signals S2L and S2R; the listener is caused to hear the sound of the output signals S2L and S2R.

(2-2) Procedure of Pseudo-Stereo Signal Making Process

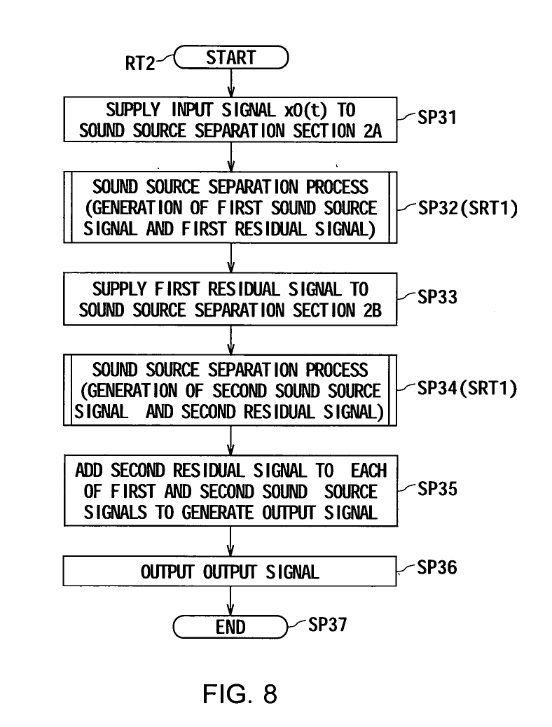

According to a different procedure from that of the pseudo-stereo signal making apparatus 1 according to the first embodiment described above, the pseudo-stereo signal making apparatus 30 outputs a pseudo-stereo sound created based on a monaural sound signal. This procedure of pseudo-stereo signal making process will be described with reference to a flowchart of FIG. 8.

When a monaural analog input signal S0 is received from the outside via the input terminal 11, the process of the pseudo-stereo signal making apparatus 30 starts with start step of routine RT2 and proceeds to step SP31. In step SP31, similarly to step SP1 (FIG. 5), the pseudo-stereo signal making apparatus 30 converts the monaural input signal S0 from analog to digital form, partitions the monaural input signal S0 for each one frame, and supplies the partitioned input signal xo(t) from the signal partition processing circuit 13 to the sound source separation section 2A. Subsequently, the flow proceeds to step SP32.

In step SP32, by executing a sequence of process steps of the sound source separation subroutine SRT1 (FIG. 6) by means of the sound source separation section 2A, the pseudo-stereo signal making apparatus 30 separates the input signal xo(t) into the first sound source signal DS1 and first residual signal DT1 by use of generalized harmonic analysis, and then returns to routine RT2 and proceeds to step SP33.

In step SP33, the pseudo-stereo signal making apparatus 30 supplies the first residual signal DT1 created by the sound source separation section 2A to the sound source separation section 2B, and then proceeds to step SP34.

In step SP34, by executing a sequence of process steps of the sound source separation subroutine SRT1 (FIG. 6) by means of the sound source separation section 2B, the pseudo-stereo signal making apparatus 30 separates the first residual signal DT1 instead of the input signal xo(t) into the second sound source signal DS2 and second residual signal DT2 by use of generalized harmonic analysis, and then returns to routine RT2 and proceeds to step SP35.

In step 35, the pseudo-stereo signal making apparatus 30 adds the second residual signal DT2 to each of the first sound source signal DS1 and second sound source signal DS2 by means of the adders 35A and 35B of the output processing section 32 to thereby generate the digital output signals D2L and D2R. Then the flow proceeds to step SP36.

In step SP36, by means of the digital/analog processing circuits 18L and 18R and amplifiers 19L and 19R of the output processing section 32, the pseudo-stereo signal making apparatus 30 converts the digital output signals D2L and D2R from digital to analog form, amplifies the analog signals and thereby generates the output signals S2L and S2R, and outputs these signals via the output terminals 20L and 20R. Then, the flow proceeds to SP37, and routine RT2 is terminated.

Consequently, the pseudo-stereo signal making apparatus 30 can separate the input signal xo(t) into the first sound source signal DS1 and first residual signal DT1 by use of generalized harmonic analysis, and can separate this same first residual signal DT1 into the second sound source signal DS2 and second residual signal DT2 by reuse of generalized harmonic analysis.

Accordingly, with the pseudo-stereo signal making apparatus 30, for example, when the sound component energy of violoncello is largest and that of violin is second largest in a sound signal obtained by recording an orchestra performance, the sound component of violoncello and that of violin can be separated as the first sound source signal DS1 and second sound source signal DS2, respectively, from the second residual signal DT2 composed of the sounds of other musical instruments.

For example, the pseudo-stereo signal making apparatus 30 can generate the output signal S2L containing the sounds of violoncello and other musical instruments other than violin by adding the second residual signal DT2 to the first sound source signal DS1 in the output processing section 32, and can also generate the output signal S2R containing the sounds of violin and other musical instruments other than violoncello by adding the second residual signal DT2 to the second sound source signal DS2.

By sending the output signals S2L and S2R to the acoustic units 6L and 6R of the headphone 6, respectively, the pseudo-stereo signal making apparatus 30 can allow the listener to hear a pseudo-stereo sound different from that of the first embodiment in such a way that the sound of violoncello is heard only from the left channel, the sound of violin only from the right channel, and the sound of other musical instruments from both the left and right channels.

(2-3) Operation and Effect

With the above described configuration, the pseudo-stereo signal making apparatus 30 supplies to the sound source separation section 2A an input signal xo(t) obtained by converting a monaural analog input signal S0 from analog to digital form and partitioning the digital signal for each one frame of a predetermined period of time, and separates the resultant signal into a first sound source signal DS1 and first residual signal DT1 by use of generalized harmonic analysis in the sound source separation section 2A similar to the sound source separation section 2 according to the first embodiment, and in addition, supplies this same first residual signal DT1 to the sound source separation section 2B to separates it into a second sound source signal DS2 and second residual signal DT2 by use of generalized harmonic analysis in the sound source separation section 2B. Subsequently, by means of the output processing section 32, the pseudo-stereo signal making apparatus 30 adds the second residual signal DT2 to the first sound source signal DS1 to thereby generate an output signal S2L, and at the same time adds the second residual signal DT2 to the second sound source signal DS2 to thereby generate an output signal S2R, and then sends the output signals S2L and S2R to the acoustic units 6L and 6R of the headphone 6, respectively.

Accordingly, the pseudo-stereo signal making apparatus 30 can separate the input signal xo(t) into the first sound source signal DS1, second sound source signal DS2 and second residual signal DT2 by performing the sound source separation process in two phases by use of generalized harmonic analysis similar to that of the first embodiment in the sound source separation sections 2A and 2B.

In this case, the pseudo-stereo signal making apparatus 30 can generate the first sound source signal DS1 and second sound source signal DS2 based on a periodic wave having the largest energy and one having the second largest energy, respectively, from among the sound components contained in the input signal xo(t), and at the same time can also generate the second residual signal DT2 corresponding to the residual components thereof.

The pseudo-stereo signal making apparatus 30 can generate the output signals S2L and S2R uncorrelated to each other by adding the second residual signal DT2 to the first sound source signal DS1 and adding the second residual signal DT2 to the second sound source signal DS2 by means of the output processing section 32. The pseudo-stereo signal making apparatus 30 sends the output signals S2L and S2R to the acoustic units 6L and 6R of the headphone 6, respectively, thereby allowing the listener to hear the pseudo-stereo sound.

For example, based on a monaural sound obtained by recording an orchestra performance, the pseudo-stereo signal making apparatus 30 can allow the listener to hear the sound of violoncello being the first sound source signal DS1 only from the left channel, the sound of violin being the second sound source signal DS2 only from the right channel, and the sound of other musical instruments being the second residual signal DT2 from both the left and right channels. Consequently, the sound image of violoncello and violin can be localized left and right, respectively, and in addition, the sound image of other musical instruments can be localized at the center. Thus the pseudo-stereo signal making apparatus 30 can allow the listener to hear a pseudo-stereo sound which has no deflection of sound image and satisfactory separation of sound sources.

With the above described configuration, by means of the sound source separation section 2A, the pseudo-stereo signal making apparatus 30 separates the input signal xo(t) into the first sound source signal DS1 and first residual signal DT1 by use of generalized harmonic analysis, and in addition, separates this same residual signal DT1 into the second sound source signal DS2 and second residual signal DT2 by use of generalized harmonic analysis by means of the sound source separation section 2B, and then, by means of the output processing section 32, adds the second residual signal DT2 to the first sound source signal DS1 to thereby generate the output signal S2L, and at the same time, adds the second residual signal DT2 to the second sound source signal DS2 to thereby generate the output signal S2R. Subsequently, by causing the listener to hear the sound of the output signals S2L and S2R via the headphone 6, the listener can hear the pseudo-stereo sound obtained by assigning the sound of the first sound source signal DS1 based on the monaural input signal S0 and that of the second sound source signal DS2 also based on the monaural input signal S0 to the left and right units of the headphone 6, respectively, and at the same time, localizing the sound of the second residual signal DT2 at the center in a lateral direction. Accordingly, there can be implemented the pseudo-stereo signal making apparatus capable of allowing the listener to hear a pseudo-stereo sound giving a significantly small unpleasant feeling.

### (3) Third Embodiment

(3-1) Configuration of Pseudo-Stereo Signal Making Apparatus

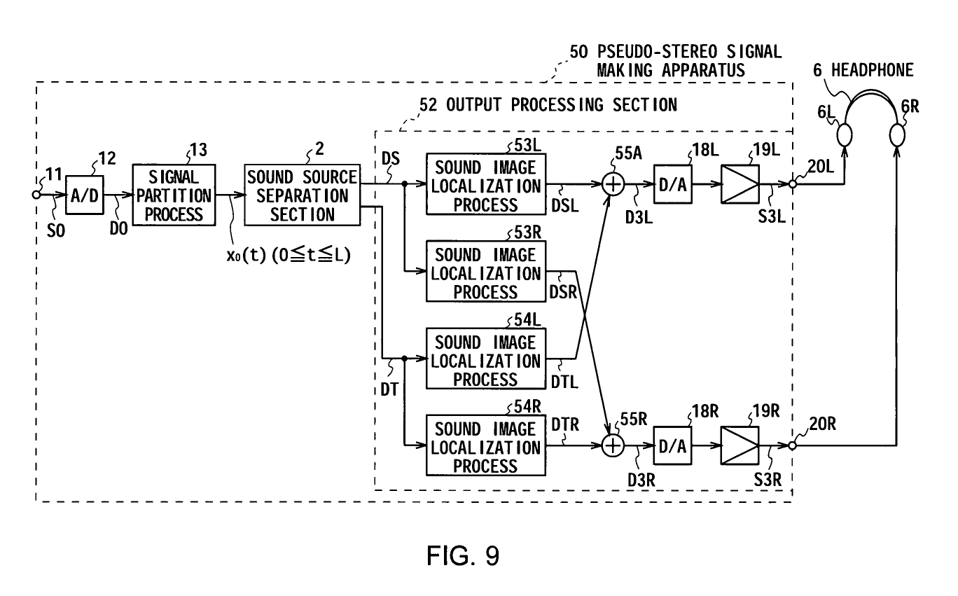

In FIG. 9 in which the same reference numerals are applied to parts corresponding to FIG. 4, reference numeral 50 denotes a pseudo-stereo signal making apparatus according to a third embodiment. The pseudo-stereo signal making apparatus 50 includes a sound source separation section 2 having a similar configuration to the sound source separation section 2 of the pseudo-stereo signal making apparatus 1 (FIG. 4), and has a similar configuration to that of the first embodiment except that it has an output processing section 52 instead of the output processing section 3.

Similarly to the first embodiment, the sound source separation section 2 separates the sound source signal DS from the residual signal DT based on one frame of input signal xo(t) acquired from the signal partition processing circuit 13, and supplies these signals to the output processing section 52.

In the output processing section 52, the sound source signal DS and residual signal DT supplied from the sound source separation section 2 are supplied to sound image localization processing circuits 53L and 53R and sound image localization processing circuits 54L and 54R, respectively.

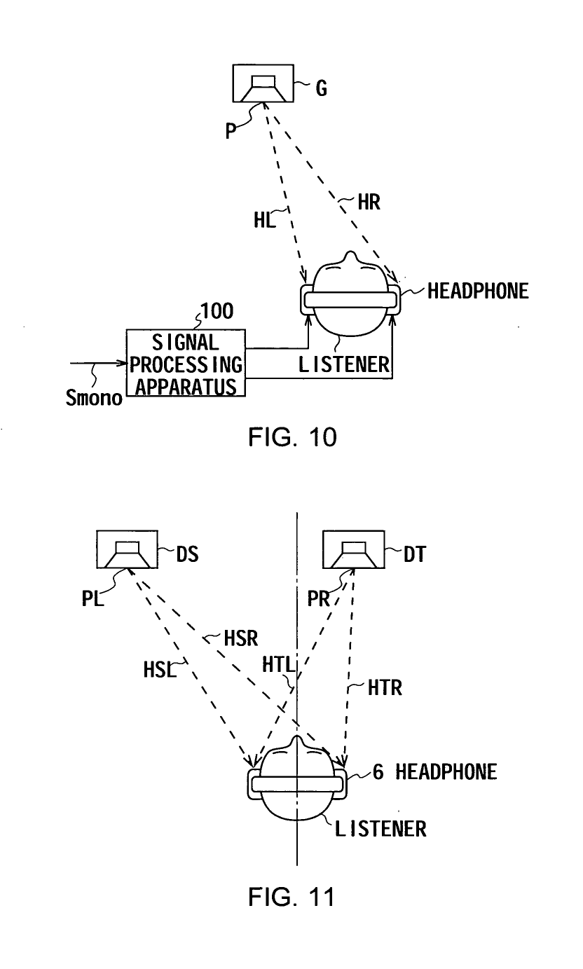

The sound image localization processing circuits 53L, 53R, 54L and 54R will now be described. For example, assuming that a sound source G is located at a position P in front of a listener as shown in FIG. 10, the distance and angle from the sound source G to the listener's left ear is different from those from the sound source G to the listener's right ear. Consequently, by hearing two slightly different sounds through the left and right ears, the listener can perceive, based on the difference between the two sounds heard by the left and right ears, that the sound source G is located at the position P. In this case, it can be presumed that the sound outputted from the sound source G reaches the listener's left and right ears via two routes having transfer functions HL and HR; thus the impulse responses of the left and right channels obtained by converting these transfer functions HL and HR from frequency to time axis are preliminarily measured or calculated.

Next, assume that a listener hears the sound via the headphone. When the listener hears completely the same sound (i.e., monaural sound) from the left and right ears via the headphone, it is perceived by the listener that the sound image is localized at the center in a lateral direction. In this case, if a monaural sound signal Smono is assigned to the left and right sound signals by means of a signal processing apparatus 100, and when a convolution of the above impulse responses of the left and right channels with the left and right sound signals is performed (hereinafter, this process is referred to as a sound image localization process), then if the listener hears the sound based on the resultant left and right sound signals via the headphone, the listener can perceive that the sound image is located at the position P.

Accordingly, the output processing section 52 of the pseudo-stereo signal making apparatus 50 performs the sound image localization process by means of the sound image localization processing circuits 53L, 53R, 54L and 54R so that the sound of the sound source signal DS and that of the residual signal DT are localized at different positions.

Specifically, as shown in FIG. 11, the sound image localization processing circuits 53L and 53R of the output processing section 52 performs, based on transfer functions HSL and HSR such that the sound image is localized at a position PL in the front left side of the listener, a convolution of the impulse responses of the left and right channels obtained by converting the transfer functions HSL and HSR from frequency to time axis with the sound source signal DS as the sound image localization process to thereby generate localized sound source signals DSL and DSR, and supplies these signals to adders 55L and 55R.

Also, the sound image localization processing circuits 54L and 54R of the output processing section 52 performs, based on transfer functions HTL and HTR such that the sound image is localized at a position PR in front of the listener at a slightly right position from the center, a convolution of the impulse responses of the left and right channels obtained by converting the transfer functions HTL and HTR from frequency to time axis with the residual signal DT as the sound image localization process to thereby generate localized residual signals DTL and DTR, and supplies these signals to adders 55L and 55R.

Then, in the output processing section 52 (FIG. 9), the localized sound source signal DSL and localized residual signal DTL are added by the adder 55L to generate a digital output signal D3L, and the localized sound source signal DSR and localized residual signal DTR are added by the adder 55R to generate a digital output signal D3R.

In addition, in the output processing section 52, the digital output signals D3L and D3R are converted from digital to analog form by digital/analog processing circuits 18L and 18R, respectively. Then the resultant signals are amplified by amplifiers 19L and 19R, respectively, to generate an output signal S3L as first output signal and an output signal S3R as second output signal. The output signals are sent to left and right acoustic units 6L and 6R of the headphone 6 via output terminals 20L and 20R, respectively.

As such, the pseudo-stereo signal making apparatus 50 separates an input signal xo(t) obtained by converting a monaural input signal S0 from analog to digital form into a sound source signal DS and residual signal DT by means of the sound source separation section 2, and then generates output signals S3L and S3R such that the sound source signal DS is localized at the front left side position and at the same time the residual signal DT is localized in front of the listener at a slightly right position from the center, thereby allowing the listener to hear the sound of the output signals S3L and S3R.

(3-2) Procedure of Pseudo-Stereo Signal Making Process

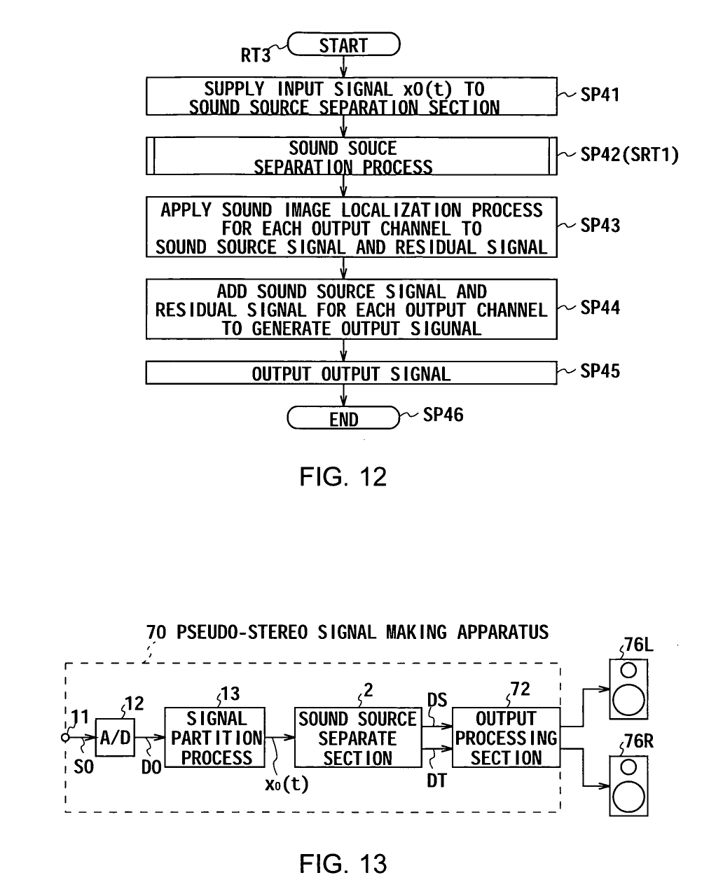

The procedure of pseudo-stereo signal making process performed by the pseudo-stereo signal making apparatus 50 to output the pseudo-stereo sound created based on a monaural sound signal will now be described with reference to a flowchart of FIG. 12.

When a monaural analog input signal S0 is received from the outside via the input terminal 11, the process of the pseudo-stereo signal making apparatus 50 starts with start step of routine RT3 and proceeds to step SP41. In step SP41, similarly to step SP1 (FIG. 5), the pseudo-stereo signal making apparatus 50 converts the monaural input signal S0 from analog to digital form, partitions the monaural input signal S0 for each one frame (0≦t≦L), and supplies the partitioned input signal xo(t) from the signal partition processing circuit 13 to the sound source separation section 2. Subsequently, the flow proceeds to step SP42.

In step SP42, by executing a sequence of process steps of the sound source separation subroutine SRT1 (FIG. 6) by means of the sound source separation section 2, the pseudo-stereo signal making apparatus 50 separates the input signal xo(t) into a sound source signal DS and residual signal DT, and then supplies the sound source signal DS to the sound image localization processing circuits 53L and 53R of the output processing section 52 and at the same time supplies the residual signal DT to the sound image localization processing circuits 54L and 54R of the output processing section 52. Subsequently, the flow returns to routine RT3 and proceeds to step SP43.

In step SP43, the pseudo-stereo signal making apparatus 50 applies the sound image localization process to the sound source signal DS by means of the sound image localization processing circuits 53L and 53R and thereby generates the localized sound source signals DSL and DSR and supplies the generated signals to the adders 55L and 55R, respectively, and at the same time applies the sound image localization process to the residual signal DT by means of the sound image localization processing circuits 54L and 54R and thereby generates the localized residual signals DTL and DTR and supplies the generated signals to the adders 55L and 55R, respectively. Subsequently, the flow proceeds to step SP44.

In step SP44, the pseudo-stereo signal making apparatus 50 adds the localized sound source signal DSL to the localized residual signal DTL by means of the adder 55L to generate a digital output signal D3L, and at the same time, adds the localized sound source signal DSR to the localized residual signal DTR by means of the adder 55R to generate a digital output signal D3R. Subsequently, the flow proceeds to step SP45.

In step SP45, by means of the digital/analog processing circuits 18L and 18R and amplifiers 19L and 19R of the output processing section 52, the pseudo-stereo signal making apparatus 50 converts the digital output signals D3L and D3R from digital to analog form and amplifies the analog signals and thereby generates output signals S3L and S3R, and outputs these signals via the output terminals 20L and 20R. Then, the flow proceeds to SP46, and routine RT3 is terminated.

Consequently, similarly to the first embodiment, the pseudo-stereo signal making apparatus 50 can separate the input signal xo(t) into the sound source signal DS and residual signal DT by use of generalized harmonic analysis in the sound source separation section 2. For example, when the signal intensity of the sound component of violoncello is largest among recorded sound signals of an orchestra performance, the sound component of violoncello can be selected as the sound source signal DS; the signal DS can be separated from the residual signal DT composed of the sound components of other musical instruments.

In addition, the pseudo-stereo signal making apparatus 50 outputs the output signals S3L and S3R obtained by applying the sound image localization process by means of the sound image localization processing circuits 53L, 53R, 54L and 54R of the output processing section 52 and then performing the addition process, to the acoustic units 6L and 6R of the headphone 6, respectively, whereby the listener can hear the pseudo-stereo sound in which the sound image of the sound source signal DS composed of the sound component of violoncello is localized at the front left side position and the residual signal DT composed of the sound components of other musical instruments is localized in front of the listener at a slightly right position from the center (FIG. 11).

(3-3) Operation and Effect

With the above configuration, the pseudo-stereo signal making apparatus 50 supplies to the sound source separation section 2 an input signal xo(t) obtained by converting an analog input signal S0 from analog to digital form and partitioning the digital signal for each one frame of a predetermined period of time, and separates the resultant signal into a sound source signal DS and residual signal DT by means of the sound source separation section 2 similar to the first embodiment. Then, the sound image localization processing is applied to the sound source signal DS and residual signal DT by the sound image localization processing circuits 53L, 53R, 54L and 54R of the output processing section 52 to generate the localized sound source signals DSL and DSR and localized residual signals DTL and DTR. Subsequently, the localized sound source signal DSL and localized residual signal DTL are added to each other to generate an output signal S3L and at the same time the localized sound source signal DSR and localized residual signal DTR are added to each other to generate an output signal S3R. The listener is caused to hear the output signals S3L and S3R via the headphone 6.

Consequently, the pseudo-stereo signal making apparatus 50 can separate the sound source signal DS from the residual signal DT based on the input signal xo(t) by performing the sound source separation process using generalized harmonic analysis in the sound source separation section 2 similarly to the first embodiment; for example, the recorded sound signal of an orchestra performance can be separated into the sound component of violoncello and that of other musical instruments.

The pseudo-stereo signal making apparatus 50 outputs the output signals D3L and D3R obtained by applying the sound image localization process to the sound source signal DS and residual signal DT by means of the sound image localization processing circuits 53L, 53R, 54L and 54R of the output processing section 52 and then adding the resultant signals, to the acoustic units 6L and 6R of the headphone 6, respectively, whereby the listener can hear the pseudo-stereo sound.

In this case, by means of the sound image localization process by the output processing section 52, the pseudo-stereo signal making apparatus 50 can allow the listener to hear the pseudo-stereo sound in which the sound image of the sound source signal DS composed of the sound component, for example, of violoncello is localized at the front left side position and the sound image of the residual signal DT composed of the sound components of other musical instruments is localized in front of the listener at a slightly right position from the center (FIG. 11), whereby the listener can perceive a laterally broadened sound field.

With the above configuration, the pseudo-stereo signal making apparatus 50 separates an input signal xo(t) into a sound source signal DS and residual signal DT by use of generalized harmonic analysis by means of the sound source separation section 2, and then, by means of the output processing section 52, applies the sound image localization process to this same sound source signal DS and residual signal DT and adds the resultant signals to thereby generate output signals S3L and S3R. The listener is caused to hear the sound of the output signals S3L and S3R via the headphone 6, thereby allowing the listener to perceive a laterally broadened sound field in which the sound image based on the sound source signal DS and residual signal DT is localized at a desired position in a lateral direction. Accordingly, there can be implemented the pseudo-stereo signal making apparatus capable of allowing the listener to hear a pseudo-stereo sound which gives a significantly small unpleasant feeling.

### (4) Another Embodiment

In the first to third embodiments described above, there is described the case where the output signals S1 to S3 are sent via the headphone 6. The present invention is, however, not limited thereto. For example, as shown in FIG. 13 in which the same reference numerals are applied to parts corresponding to FIG. 4, the pseudo-stereo signal making apparatus 70 may send the output signals to loudspeakers 76 instead of to the headphone 6 to cause the listener to hear the pseudo-stereo sound.

In this case, in addition to the configuration in which the output signals are sent from the output processing section 72 to two loudspeakers 76L and 76R, the pseudo-stereo signal making apparatus 70 may generate three or more kinds of output signals in the output processing section 72 and send the output signals to three or more loudspeakers 76 to reproduce the sound.

It is noted here that the output processing section 72, though having a configuration similar to that of the output processing section 3 (FIG. 4), amplifies the output signals up to a signal level capable of driving the loudspeakers 76L and 76R instead of the headphone 6 before sending them.

In the second embodiment described above, there is described the case where two stages of the sound source separation section 2 (sound source separation sections 2A and 2B) are used to create two sound source signals DS (sound source signals DS1 and DS2). The present invention is, however, not limited thereto; three or more stages of the sound source separation section 2 may be used to separate three or more sound source signals DS.

In this case, in addition to the configuration in which each of the sound source signal DS and residual signal DT thus created is appropriately assigned to one of the left or right channels, the sound image of each of the sound source signal DS and residual signal DT may be localized at a desired position by applying the sound image localization process as with the third embodiment.

Also, in the second embodiment described above, there is described the case where the output signal S2L obtained by adding the first sound source signal DS1 and second residual signal DT2 is assigned to the left channel, and the output signal S2R obtained by adding the second sound source signal DS2 and second residual signal DT2 is assigned to the right channel to cause the listener to hear them. The present invention is, however, not limited thereto; another method of assigning the output signals may be employed such as one in which, while the output signal obtained by adding the first sound source signal DS1 and second residual signal DT2 is assigned to the left channel, the second residual signal DT2 is assigned to the right channel.

Also, in the third embodiment described above, there is described the case where the output signals S3L and S3R are generated by the sound image localization processing circuits 53L, 53R, 54L and 54R of the output processing section 52 such that the sound source signal DS is localized at the front left side position and at the same time, the residual signal DT is localized in front of the listener at a slightly right position from the center. The present invention is, however, not limited thereto; the output signals S3L and S3R may be generated such that each of this same sound source signal DS and residual signal DT is localized at another position.

Also, in the first to third embodiments described above, there is described the case where two channels of output signals S1L and S1R are generated based on the monaural input signal S0. The present invention is, however, not limited thereto. For example, any number of multiple channels of output signals may be generated by applying the sound source separation process to each of any number of multiple channels of input signals, such as generating four channels of output signals by applying the sound source separation process for each input channel with respect to a stereo input signal.

Also, in the first to third embodiments described above, there is described the case where frequency f is changed by 10 Hz in a frequency range from 20 Hz to 20 kHz in the frequency spectrum analysis processing circuits 14, 14A and 14B of the sound source separation sections 2, 2A and 2B (steps SP11 to SP15). The present invention is, however, not limited thereto; the frequency f may be changed appropriately from any given start frequency to any given end frequency.

Also, in the first to third embodiments described above, there is described the case where eight kinds of frequencies, i.e., fundamental frequency f₁ and sub frequencies f₂ to f₈ are selected in order of small energy E(f) of residue in the frequency spectrum analysis processing circuits 14, 14A and 14B of the sound source separation sections 2, 2A and 2B. The present invention is, however, not limited thereto; any number of sub frequencies may be selected.

Also, in the first to third embodiments described above, there is described the case where sub frequencies f₂ to f₈ being approximately integral multiples of fundamental frequency f₁ are selected as the harmonic waves thereof by the harmonic wave extraction processing circuits 16, 16A and 16B of the sound source separation sections 2, 2A and 2B. The present invention is, however, not limited thereto; the harmonic waves may be selected by use of the correlation between the temporal change of fundamental frequency f₁ and that of sub frequencies f₂ to f₈.

Also, in the first to third embodiments described above, there is described the case where the sound source signal DS and residual signal DT, or the first sound source signal DS1, second sound source signal DS2 and second residual signal DT2 obtained by performing the sound source separation process by means of the sound source separation section 2, or the sound source separation sections 2A and 2B of the pseudo-stereo signal making apparatuses 1, 30 and 50 are converted from digital to analog form by the output processing section 3, 32 and 52 to cause the listener to hear it. The present invention is, however, not limited thereto. For example, the sound source signal DS, residual signal DT, and so on, obtained by performing the sound source separation process by means of the pseudo-stereo signal making apparatuses 1, 30 and 50 may be sent as digital data to a network terminal apparatus of a listener via the network to perform a similar process to that of the output processing section 3, 32 and 52 in the network terminal apparatus, whereby the listener is caused to hear the pseudo-stereo sound.

Also, in the first to third embodiments described above, there is described the case where the monaural input signal S0 is converted into the pseudo-stereo signal in real time to cause the listener to hear it. The present invention is, however, not limited thereto; the sound source signal DS and residual signal DT, or the digital output signals D2L and D2R, and D3L and D3R obtained by performing the sound source separation process based on the monaural input signal S0 by means of the sound source separation section 2 (or sound source separation sections 2A and 2B) may be saved as digital sound data into a predetermined storage medium, and later, this same digital sound data is converted from digital to analog form to allow the listener to hear the sound.

For example, by saving preliminarily the generated digital sound data into a Compact Disc-Recordable (CD-R) or the like, the pseudo-stereo signal making apparatus 1 can allow the listener who plays back the CD-R with a CD player, and so on, to hear the pseudo-stereo sound. Alternatively, by receiving the input signal xo(t) from the outside, for example, via the network, and storing the sound source signal DS and residual signal DT separated by the above described sound source separation process into a storage unit, such as a hard disk drive, as digital sound data, and later sending this same digital sound data to a network terminal apparatus of the listener via the network, the pseudo-stereo signal making apparatus 1 may allow the listener to hear the pseudo-stereo sound from the network terminal apparatus.

Also, in the first to third embodiments described above, there is described the case where the present invention is applied to the pseudo-stereo signal making apparatuses 1, 30 and 50 which separate the digital input signal D0 into the sound source signal DS and residual signal DT by means of the hardware configuration. The present invention is, however, not limited thereto; by installing a pseudo-stereo signal making program performing the above described signal partition process, frequency spectrum analysis process, fundamental periodic wave extraction process, harmonic extraction process and waveform combination process, for example, into an information processing apparatus of a personal computer or the like, the sound source separation process may be performed by the information processing apparatus.

In this case, as a program storage medium for installing the pseudo-stereo signal making program into the information processing apparatus to make the program executable, not only package media, such as flexible disk, Compact Disc-Read Only Memory (CD-ROM) and Digital Versatile Disc (DVD), but also semiconductor memory or magnetic disk for storing such program temporarily or permanently can be employed.

As means for storing such program into the program storage medium, wired and wireless communication media, such as local area network, the Internet and digital satellite broadcasting, may be used; the program may be stored via various kinds of communication interfaces such as router and modem.

Also, in the third embodiment described above, there is described the case where the sound image localization process of localizing the sound image is performed by the sound source localization processing circuits 53L and 53R, and 54L and 54R of the output processing section 52 having a hardware configuration. The present invention is, however, not limited thereto. For example, the sound image localization program for performing the sound image localization process may be stored preliminarily into a storage unit (not shown) of the output processing section 52, whereby a control section (not shown) in the output processing section 52 executes the sound image localization program to localize the sound image.

Also, in the first embodiment described above, there is described the case where the pseudo-stereo signal making apparatus 1 as pseudo-stereo signal making unit is composed of the sound source separation section 2 as sound source separation section and the output processing section 3 as output signal generation section. The present invention is, however, not limited thereto; the pseudo-stereo signal making apparatus may be composed of sound source separation section and output signal generation section each having various other circuit configurations.

The present invention can be applied not only to a pseudo-stereo signal making apparatus allowing the listener to hear a pseudo-stereo sound via the headphone but also to a pseudo-stereo signal making apparatus allowing the listener to hear a pseudo-stereo sound via loudspeakers.

It should be understood by those skilled in the art that various modifications, combinations, sub-combinations and alterations may occur depending on design requirements and other factors insofar as they art within the scope of the appended claims or the equivalents thereof.

1. A pseudo-stereo signal making apparatus for converting a monaural sound into a pseudo-stereo sound, the pseudo-stereo signal making apparatus comprising:
sound source separation means for generating a sound source signal component and at the same time generating a residual signal obtained by subtracting the sound source signal component from an input signal, the sound source signal component being generated by acquiring the input signal composed of a monaural sound partitioned into predetermined analysis intervals, selecting from among periodic waves extractable from the input signal a fundamental periodic wave component such that an energy of residual components obtained by subtracting the periodic wave component from the input signal is minimal, and then extracting the fundamental periodic wave component and harmonic wave components thereof from the input signal and combining them; and
output signal generation means for generating, based on the sound source signal, a first output signal corresponding to one channel and at the same time generating, based on the residual signal, a second output signal corresponding to another channel.

2. The pseudo-stereo signal making apparatus according to claim 1, wherein
the output signal generation means generates the first output signal by combining the sound source signal component and the residual signal, and at the same time generates the second output signal based on the residual signal.

3. The pseudo-stereo signal making apparatus according to claim 1, wherein
the output signal generation means generates the first output signal and the second output signal by applying a sound image localization process to each of the sound source signal component and the residual signal, so that the sound image of the sound based on the sound source signal component and the sound image of the sound based on the residual signal are localized at predetermined positions, respectively.

4. The pseudo-stereo signal making apparatus according to claim 1, further comprising
second sound source separation means that generates a second sound source signal component and at the same time generates a second residual signal obtained by subtracting the second sound source signal component from the residual signal, selecting from among periodic waves extractable from the residual signal a second fundamental frequency such that an energy of residual components obtained by subtracting the periodic wave from the residual signal is minimal, and then extracting the second fundamental periodic wave component and harmonic wave components thereof from the residual signal and combining them, wherein the output signal generation means combines the sound source signal component and second residual signal to generate the first output signal, and at the same time combines the second sound source signal component and second residual signal to generate the second output signal.

5. The pseudo-stereo signal making apparatus according to claim 4, wherein
the output signal generation means generates the first output signal and second output signal by applying a sound image localization process to each of the sound source signal component, the second sound source signal component and the second residual signal, so that the sound image of the sound based on the sound source signal component, the sound image of the sound based on the second sound source signal, and the sound image of the sound based on the second residual signal are localized at predetermined positions, respectively.

6. The pseudo-stereo signal making apparatus according to claim 1, wherein
the sound source separation means acquires the input signal so that the analysis interval thereof overlaps with an analysis interval of an input signal previously acquired.

7. A pseudo-stereo signal making method for converting a monaural sound into a pseudo-stereo sound, the pseudo-stereo signal making method comprising:
a sound source separation step of generating a sound source signal component and at the same time generating a residual signal obtained by subtracting the sound source signal component from an input signal, the sound source signal component being generated by acquiring the input signal composed of a monaural sound partitioned into predetermined analysis intervals, selecting from among periodic waves extractable from the input signal a fundamental periodic wave component such that an energy of residual components obtained by subtracting the periodic wave component from the input signal is minimal, and then extracting the fundamental periodic wave component and harmonic wave components thereof from the input signal and combining them; and
an output signal generation step of generating, based on the sound source signal component, a first output signal corresponding to one channel and at the same time generating, based on the residual signal, a second output signal corresponding to another channel.

8. A pseudo-stereo signal making program causing an information processing apparatus to execute a process of converting a monaural sound into a pseudo-stereo sound, the pseudo-stereo signal making program comprising:
a sound source separation step of generating a sound source signal component and at the same time generating a residual signal obtained by subtracting the sound source signal component from an input signal, the sound source signal component being generated by acquiring the input signal composed of a monaural sound partitioned into predetermined analysis intervals, selecting from among periodic waves extractable from the input signal a fundamental periodic wave component such that an energy of residual components obtained by subtracting the periodic wave component from the input signal is minimal, and then extracting the fundamental periodic wave component and harmonic wave components thereof from the input signal and combining them; and
an output signal generation step of generating, based on the sound source signal component, a first output signal corresponding to one channel and at the same time generating, based on the residual signal, a second output signal corresponding to another channel.
